(19) United States
(12) Patent Application Publication
(10) Pub. No.: US 2024/0323767 A1
(43) Pub. Date: Sep. 26, 2024

(54) METHOD AND SYSTEM FOR DEPLOYING APPLICATION SERVERS ON FEDERATED EDGE NETWORKS

(71) Applicant: Samsung Electronics Co., Ltd., Suwon-si (KR)

(72) Inventor: Deepanshu GAUTAM, Bangalore (IN)

(21) Appl. No.: 18/615,034

(22) Filed: Mar. 25, 2024

(30) Foreign Application Priority Data
Mar. 24, 2023 (IN) 202341021016
Jan. 25, 2024 (IN) 2023 41021016

(51) Int. Cl. H04W 28/26; H04L 5/00

(52) U.S. Cl. CPC H04W 28/26; H04L 5/0048

(57) ABSTRACT

The disclosure relates to a 5G or 6G communication system for supporting a higher data transmission rate. A method performed by a leading operator platform (L-OP) for deploying application servers on a federated edge network is provided. The method includes receiving, from an application service provider (ASP), a deployment request for deploying an application server, whether the L-OP is able to deploy at least one application server based on the deployment request, and in case that the L-OP is not able to deploy the at least one application server, selecting participating operator platform (P-OP) from a plurality of P-OPs having a predefined federation association with the L-OP for management of application servers.

### CROSS-REFERENCE TO RELATED APPLICATION(S)

This application is based on and claims priority under 35 U.S.C. § 119(a) of an Indian Provisional patent application No. 20/234,1021016, filed on Mar. 24, 2023, in the Indian Patent Office, and of an Indian Complete patent application Ser. No. 20/234,1021016, filed on Jan. 25, 2024, in the Indian Patent Office, the disclosure of each of which is incorporated by reference herein in its entirety.

### BACKGROUND

### 1. Field

The disclosure relates to the field of communication technologies. More particularly, the disclosure relates to a method and system for deploying application servers on federated edge networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Communication services associated with massive Internet of Things (IoT) connections require a support of a large number and high-density IoT devices to be efficient and cost effective. Operators use one or more network slice instances to provide these communication services, which require similar network characteristics, to different vertical industries. 3rd Generation Partnership Project (3GPP) TS 28.530 and 28.531 define management of network slices in 5th Generation (5G) networks. It also defines the concept of Communication Services, which are provided using one or multiple network slices. A Network Slice Instance (NSI) may support multiple Communication Service Instances (CSI). Similarly, a CSI may utilize multiple NSIs.

Third generation partnership project (3GPP) SA6 is working on an architecture for enabling edge computing (3GPP TR 23.558), which specifies an application framework or an enabling layer platform to support edge computing in 3GPP specified networks, (for e.g., discovery of edge services, authentication of the clients, and the like). This includes interactions between a User Equipment (UE) and an enabling layer platform, and interactions between applications deployed over edge and the enabling layer platform. Further, it includes facilitating integration with the underlying 3GPP core network. This involves deploying Edge Application Server (EAS) or Edge Application (EA) as a piece of software running and deployed on virtual infrastructure at the edge of the 3GPP network.

Edge Federation (EF) is considered to be a crucial requirement for Fifth Generation (5G) edge network management. Existing edge management procedures allow an Application Service Provider (ASP) to request for a deployment of an EAS at an Edge Data Network (EDN) which is maintained by an operator which is in agreement with the corresponding ASP. Whereas, in an edge federation mechanism, the operators cannot request for the deployment of the EAS at the EDN of a federated or different operator. Therefore, the existing edge management procedures require an enhancement such that a Leading Operator Platform (L-OP) can request for the deployment of the EAS at the EDNs which are maintained by a Participating Operator Platform (P-OP).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and system for deploying application servers on federated edge networks.

Additional aspects will be set forth in part in the description which follows and, in part, will be apparent from the description, or may be learned by practice of the presented embodiments.

In accordance with an aspect of the disclosure, a method of deploying application servers on a federated edge network is provided. The method includes receiving, from an application service provider (ASP), a deployment request including requirements for deploying an application server, identifying whether the primary edge network node is able to deploy at least one application server based on the deployment request, in case that the primary edge network node is not able to deploy the at least one application server, selecting a secondary edge network node from a plurality secondary edge network nodes having a predefined federation association with the primary edge network node for management of application servers.

In accordance with another aspect of the disclosure, a primary edge network node of a communication network for deploying application servers on a federated edge network is provided. The primary edge network node includes one or more processors, memory communicatively coupled to the one or more processors, wherein the memory store one or more computer programs including computer-executable instructions that, when executed by the one or more processors, cause the primary edge network node to receive, from an application service provider (ASP), a deployment request including requirements for deploying an application server, identify whether the primary edge network node is able to deploy at least one application server based on the deployment request, and in case that the primary edge network node is not able to deploy the at least one application server, select a secondary edge network node from a plurality of secondary edge network nodes having a predefined federation association with the primary edge network node for management of application servers.

In accordance with another aspect of the disclosure, one or more non-transitory computer-readable storage media storing one or more computer programs including computer-executable instructions that, when executed by one or more processors of a primary edge network node, cause the primary edge network node to perform operations are provided. The operations include receiving, from an application service provider (ASP), a deployment request including requirements for deploying an application server, identifying whether the primary edge network node is able to deploy at least one application server based on the deployment request, and in case that the primary edge network node is not able to deploy the at least one application server, selecting a secondary edge network node, from a plurality of secondary edge network nodes having a predefined federation association with the primary edge network node for management of application servers.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates an embodiment for deploying application servers on federated edge networks, according to an embodiment of the disclosure;

FIG. 1B illustrates interaction of a primary edge network node with an identified secondary edge network node, according to an embodiment of the disclosure;

FIG. 2 illustrates a detailed block diagram of a primary edge network node of a communication network, according to an embodiment of the disclosure;

FIG. 3 illustrates a sequence diagram for deploying an edge application server on a federated edge network, according to an embodiment of the disclosure;

FIG. 4 illustrates a flowchart illustrating a method for deploying application servers on federated edge networks, according to an embodiment of the disclosure; and

FIG. 5 illustrates a block diagram of a system for implementing according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the document, the word “exemplary” is used herein to mean “serving as an example, instance, or illustration.” Any embodiment or implementation of the subject matter described herein as “exemplary” is not necessarily to be construed as preferred or advantageous over other embodiments.

The terms “comprises,” “comprising,” “includes” or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Currently, 5th Generation (5G) systems consist of 5G Access Network (AN), 5G Core Network (CN) and User Equipment (UE). The 5G systems are expected to provide optimized support for a variety of different communication services, different traffic loads, and different end user communities. For example, the communication services using network slicing may include vehicle to everything (V2X) services. The 5G systems aim to enhance its capability to meet Key Performance Indicators (KPIs) required by emerging V2X applications. For these advanced applications, requirements, such as data rate, reliability, latency, communication range and speed, are made more stringent with 5G seamless Enhanced Mobile Broadband (eMBB). As eMBB is one of the key technologies that enables network slicing, Fixed Mobile Convergence (FMC) which includes wireless-to-the-everything (WTTx) and fibre-to-the-everything (FTTx) are expected to provide native support for network slicing. For optimization and resource efficiency, the 5G systems select the most appropriate 3rd Generation Partnership Project (3GPP) or non-3GPP access technology for a communication service. This results in potentially allowing multiple access technologies to be used simultaneously for one or more services active on the UE, wherein massive IoT connections that support massive Internet of Things (mloT) bring many new requirements in addition to MBB enhancements. Communication services with massive IoT connections such as smart households, smart grid, smart agriculture, smart meter, and the like may require support of a large number and high-density IoT devices to be efficient and cost effective. Operators can use one or more network slice instances to provide these communication services, which require similar network characteristics, to different vertical industries. 3GPP TS 28.530 and 28.531 defines the management of network slice in 5G networks. It also defines the concept of communication services, which are provided using one or multiple network slice. A Network Slice Instance (NSI) may support multiple Communication Service Instances (CSI). Similarly, a CSI may utilize multiple NSIs.

Further, 3GPP SA6 is working on an architecture for enabling edge computing (3GPP TR 23.558), which specifies an application framework or an enabling layer platform to support edge computing in 3GPP specified networks, (e.g., discovery of edge services, authentication of the clients). The work includes interactions between the UE and the enabling layer platform, and the interactions between the applications deployed over edge and the enabling layer platform. Further, the work is to facilitate integration with the underlying 3GPP core network. The work defines Edge Application Server (EAS) or Edge Application as a piece of software running and deployed on virtual infrastructure at the edge of the 3GPP network.

Thus, existing edge management procedures allows an Application Service Provider (ASP) to request Edge Application Server (EAS) deployment at an Edge Data Network (EDN) maintained by an operator. The edge federation mechanisms require an operator to request for an EAS deployment at an EDN of a different operator. Hence, the existing edge management procedures need to be enhanced so that it can be used by a Leading Operator Platform (L-OP) to request for EAS deployment at an EDN maintained by a Participating Operator Platform (P-OP).

In an embodiment of the disclosure an operator is enabled to request for deployment of an EAS on the EDN owned by a different operator.

The disclosure provides an enhanced EAS-requirements-Instance Object Class (IOC) for using the existing procedures for EAS deployment. On receiving an EAS deployment request form ASP, the L-OP may check if it can deploy the EAS at one of its own EDN. If not, L-OP may select a P-OP and the EDN based on federation relationships which may be maintained with multiple P-OPs. Thereafter, the L-OP may send an existing create-Management Object Instance (MOI) operation for enabling EAS-requirements-IOC. The EAS-requirements-IOC may contain attributes indicating the federation, EDN, and reservations. Therefore, once the P-OP receives the request, the EAS deployment procedure may be followed as defined in 3GPP TS 28.538.

The disclosure discloses a method flow that may include establishment of a federation between L-OP and P-OP. The ASP may send a create-MOI operation request to L-OP, for obtaining the EAS-requirements-IOC as defined in 3GPP TS28.538. The L-OP may send a response for the received request. On receiving the EAS deployment request form the ASP, the L-OP may check if it can deploy the EAS at one of its own EDN. If not, L-OP may select a P-OP and the EDN based on, but not limited to, the received federation, EDN, and reservation information. Thereafter, the L-OP may send an existing create-MOI operation for obtaining EAS-requirements-IOC. In an embodiment, the EAS-requirements-IOC may include predefined attributes as listed in table 1 below.

TABLE 1
Attributes for requirement IOC

| | | Cardi- | |
|---|---|---|---|
| Attribute Name | Support | nality | Description |
| federationID | M | 1 | This defines the federation ID |
| | | | provided by the P-OP to L-OP at |
| | | | the time of federation |
| | | | establishment. |
| eDNID | M | 1 | This defines the EDN identifier on |
| | | | which the EAS is to be deployed. |
| reservationID | M | 1 | This defines the reservation |
| | | | identification of the block of |
| | | | reserved resources for L-OP in |
| | | | P-OP's edge network. |

Further, the P-OP may send a response which may be followed by the EAS deployment procedure as defined in 3GPP TS 28.538. Thereafter, a notification for a successful or un-successful EAS deployment may be sent to the ASP.

An embodiment of disclosure provides a possibility for an operator to request for deployment of an EAS on the EDN owned by a different operator.

Disclosed herein is a method and a system for deploying application servers on a federated network. In existing techniques, an Application Service Provider (ASP) is allowed to request for a deployment of an Edge Application Server (EAS) at an Edge Data Network (EDN) which is maintained by an operator which is in agreement with the ASP. However, the same is not possible with edge federation mechanisms as the operator cannot requests on behalf of the ASP for the deployment of the EAS at the EDN of a federated or different operator which may not be in agreement with the corresponding ASP. Therefore, this corresponds to inefficiency in managing edge federation mechanisms. Hence, existing edge management procedures require an enhancement such that a Leading Operator Platform (L-OP) can request for the deployment of the EAS at the EDNs which are maintained by a Participating Operator Platform (P-OP).

Therefore, to solve the above problem, the disclosure discloses a method and a system for deploying application servers on federated edge networks. The disclosure facilitates the L-OP to maintain a predefined federation association with a plurality of P-OPs. As a result, the L-OP is capable of deploying the EAS on the EDN associated with one of the P-OPs from the plurality of P-OPs. In an embodiment, the L-OP may correspond to a primary edge network node and the P-OP may correspond to by a secondary edge network node. Particularly, the L-OP corresponds to the operator that intends to use edge resources of a different operator. Similarly, the P-OP corresponds to the operator that offers its edge resources to the other operators. In the disclosure, the primary edge network node is configured to receive a deployment request from the ASP and further identify a secondary edge network node and the EDN for deploying the EAS. The disclosure performs the deployment of the EAS by sending the request comprising updated deployment requirements to the identified secondary edge network node. The updated deployment requirements comprise identifier attributes associated with the secondary edge network node along with the requirements associated with the application server to be deployed. Hence, in this manner, the disclosure facilitates the L-OPs to request for the deployment of the EAS at the EDNs which are maintained by the P-OPs.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

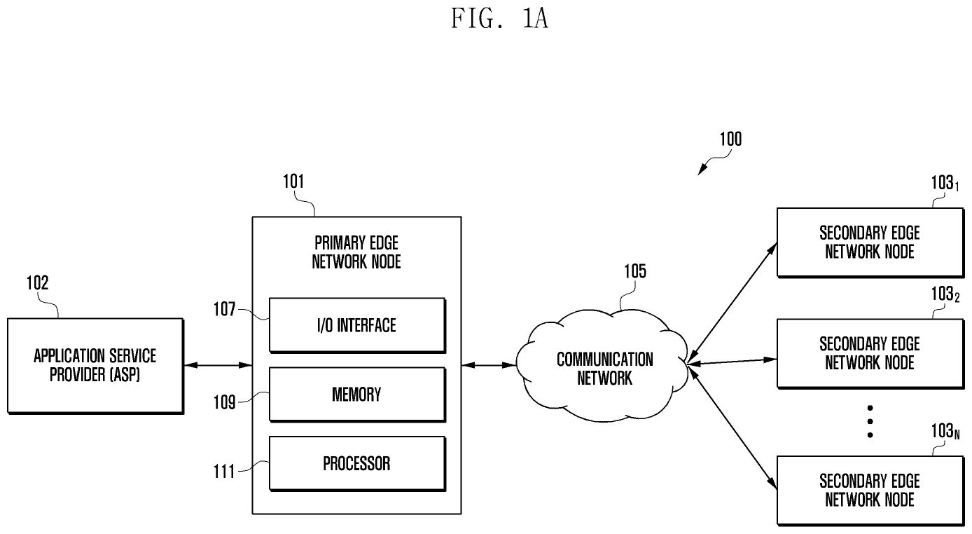

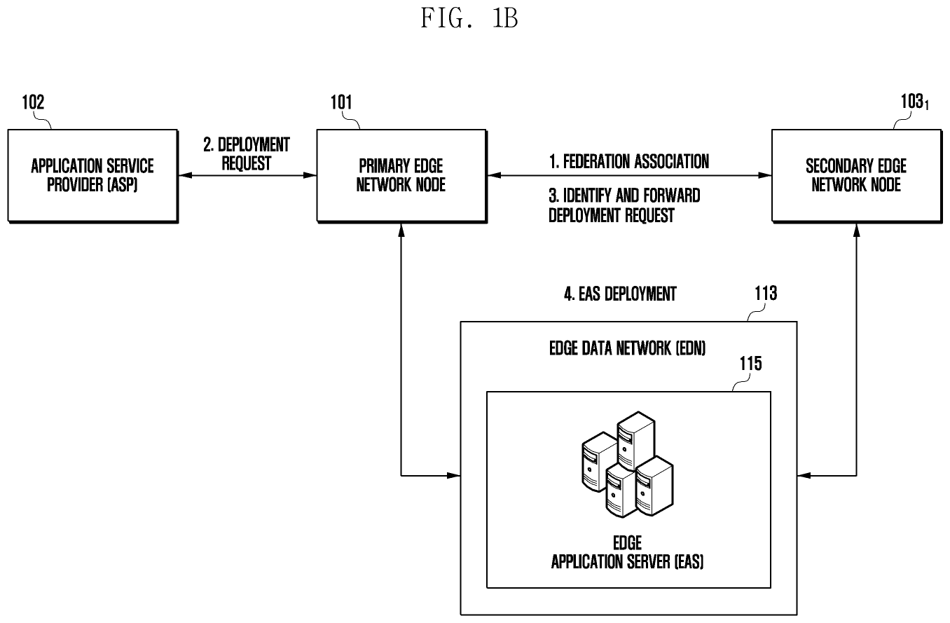

FIG. 1A illustrates an embodiment for deploying application servers on federated edge networks, according to an embodiment of the disclosure.

FIG. 1A illustrates an environment 100 for deploying application servers on federated edge networks.

Referring to FIG. 1A, the environment 100 includes a primary edge network node 101 connected with an Application Service Provider (ASP) 102 and a plurality of secondary edge network nodes 103 (such as, a secondary edge network node 1031, a secondary edge network node 1032, . . . a secondary edge network node 103x, collectively referred as a plurality of secondary edge network nodes 103, as shown in FIG. 1A) connected via a communication network 105. The primary edge network node 101 comprises an Input/Output (I/O) interface 107, memory 109 and a processor 111. In an embodiment, the environment 100 may be associated with a federated communication network. Herein, the primary edge network node 101 may correspond to a Leading Operator Platform (L-OP) also referred to as a provisioning MnS consumer. Similarly, the plurality of secondary edge network nodes 103 may correspond to a Participating Operator Platform (P-OP) also referred to as a provisioning MnS producer. Both, the provisioning MnS consumer and the provisioning MnS producer are separate entities associated with different operators, such as leading operator associated with the L-OP and participating operator associated with the P-OP, respectively. In an embodiment, the L-OP and the P-OP are capable of performing various edge federation management procedures. For example, the provisioning MnS consumer performs requesting related operations for the leading operator. Whereas the other entity i.e. the provisioning MnS producer deals with providing resources of the participating operator to the leading operator. In an embodiment, the participating operator comprises various edge resources which includes, but not limited to, Edge Application Server (EAS), Edge Enabler Server (EES), Edge Hosting Environment (EHE), and the like. These edge resources provide various edge services i.e. the services which are kept at the edge of the network which is near to the leading operator. The operators can provide edge services defined by SA6-3GPP TS 23.558.

As described above, the primary edge network node 101 is an operator who wishes to use the edge resources and corresponding edge services of the plurality of secondary edge network nodes 103 by requesting deployment of the EAS at one of the secondary edge network node, for instance, the secondary edge network node 1031. For enabling the primary edge network node 101 to use the edge resources and edge services of the secondary edge network node 1031, the disclosure discloses a technique of deploying the application servers on an EDN of a different operator.

The functioning of the primary edge network node 101 with the ASP 102 and the plurality of secondary edge network nodes 103 is implemented in the environment 100 as shown in FIG. 1A. Particularly, the primary edge network node 101 is configured to receive a deployment request from the ASP 102. The deployment request comprising requirements for deploying an application server. In an embodiment, the deployment request may be received from the ASP 102 in a form of a createMOI request operation for EASRequirements IOC as defined in 3GPP TS28.538. In an embodiment, the EASRequirements IOC may comprise attributes including but not limited to, requiredEASservingLocation, softwareImageInfo, affinity AntiAffinity, serviceContinuity, virtualResource, and the like. On receiving the deployment request, the primary edge network node 101 may send a response in a form of a createMOI response operation for EASRequirements IOC. In an embodiment, the response indicates an acknowledgement of the deployment request sent by the ASP 102.

In an embodiment, the primary edge network node 101 and each of the plurality of secondary edge network nodes 103 are associated with one or more Edge Data Networks (EDNs). Therefore, the primary edge network node 101 may first determine whether it is capable of deploying the EAS on an EDN which is maintained by itself based on the deployment request. However, on determining inability to deploy the EAS on the one or more EDNs maintained by the primary edge network node 101, a secondary edge network node such as, for instance, secondary edge network node 1031 is identified from the plurality of secondary edge network nodes 103 for deploying the requested EAS. In an embodiment, the primary edge network node 101 maintains a predefined federation association with each of the plurality of secondary edge network nodes 103. The predefined federation association is established between the primary edge network node 101 and each of the plurality of secondary edge network nodes 103 prior to receiving the deployment request for deploying the application server. Therefore, based on the deployment request, the primary edge network node 101 is configured to first identify the secondary edge network node 1031 and then identify the EDN associated with the identified secondary edge network node 1031 to proceed with the deployment of the requested EAS.

On identifying the secondary edge network node 1031 and the respective EDN for deploying the EAS, the primary edge network node 101 may send a request comprising updated deployment requirements to the identified secondary edge network node 1031. In an embodiment, the request comprising the updated deployment requirements may be sent in a form of CreateMOI (EAS Requirement IOC {federationID, eDNID, reservationID}) Request. Further, similar to original deployment request, a response in a form of a createMOI response operation for EASRequirements IOC may be received by the primary edge network node 101 from the identified secondary edge network node 1031. The updated deployment requirements comprise identifier attributes associated with the secondary edge network node 1031 along with the requirements associated with the application server to be deployed. In an embodiment, the identifier attributes may include a federation identification number (federationID), an edge data network identifier (eDNID), and a reservation identifier (reservationID). The eDNID is associated with the EDN of the secondary edge network node 1031 for deploying the EAS and the reservationID is used for identifying a block of reserved resources for the primary edge network node 101 in the secondary edge network node 1031. In an embodiment, the identifier attributes are provided by each of the plurality of secondary edge network nodes 103 to the primary edge network node 101 during establishment of the predefined federation association. Thereafter, the identified secondary edge network node 1031 deploys the EAS on the identified EDN based on the request comprising the updated deployment requirements.

In an embodiment, the EAS-requirements-IOC may include predefined attributes as listed in Table 2 below.

TABLE 2
Attributes for requirement IOC

| | | Cardi- | |
|---|---|---|---|
| Attribute Name | Support | nality | Description |
| federationID | M | 1 | This defines the federation ID |
| | | | provided by the P-OP to L-OP at |
| | | | the time of federation |
| | | | establishment. |
| eDNID | M | 1 | This defines the EDN identifier on |
| | | | which the EAS is to be deployed. |
| reservationID | M | 1 | This defines the reservation |
| | | | identification of the block of |
| | | | reserved resources for L-OP in |
| | | | P-OP's edge network. |

FIG. 1B illustrates an interaction of a primary edge network node with an identified secondary edge network node according to an embodiment of the disclosure.

Referring to step 1 of FIG. 1B, the primary edge network node 101 is in a predefined federation association with the secondary edge network node 1031. Further, as shown in step 2, the primary edge network node 101 receives a deployment request comprising requirements for deploying an EAS 115, from the ASP 102. At step 3, the primary edge network node 101 performs identification of a secondary edge network node 1031 and a corresponding EDN 113 from one or more EDNs, for deploying the EAS 115, as it determines an inability to deploy the EAS 115 at its own one or more EDNs. For illustrative purpose FIG. 1B shows identification of the secondary edge network node 1031. However, a person skilled in art may understand that the identified secondary edge network node may correspond to any one secondary edge network node from the plurality of secondary edge network nodes 103. On identifying, the primary edge network node 101 forwards the deployment request with updated requirements to a secondary edge network node 1031. Thereafter, upon forwarding the request, at step 4, the identified secondary edge network node 1031 deploys the EAS 115 on the identified EDN 113 based on the request.

A description of an embodiment with several components in communication with each other does not imply that all such components are required. On the contrary a variety of optional components are described to illustrate the wide variety of possible embodiments of the disclosure.

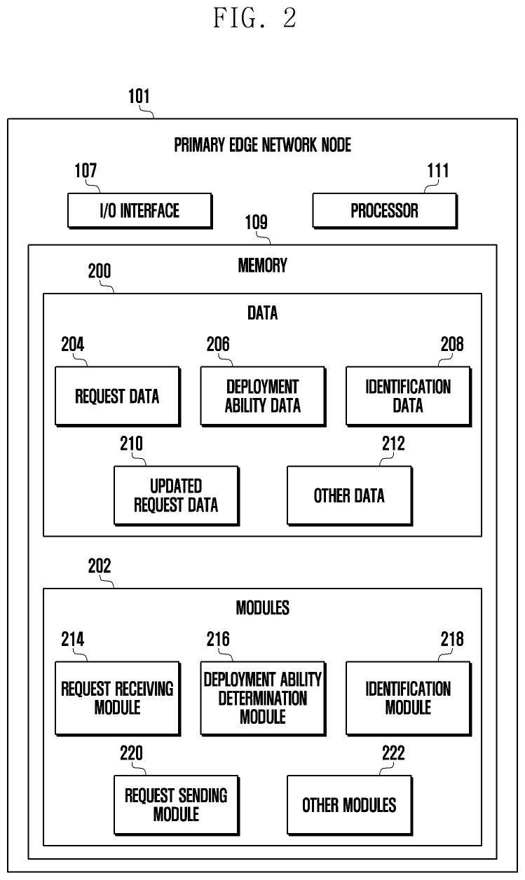

FIG. 2 illustrates a detailed block diagram of a primary edge network node of a communication network, according to an embodiment of the disclosure.

FIG. 2 illustrates internal architecture of the primary edge network node of a communication network in accordance with some embodiments of the disclosure. The primary edge network node 101 may include at least one Central Processing Unit (“CPU” or “processor”) 111 and memory 109 storing instructions executable by the at least one processor 111. The processor 111 may comprise at least one data processor for executing program components for executing user or system-generated requests. The memory 109 is communicatively coupled to the processor 111. The primary edge network node 101 further comprises an Input/Output (I/O) interface 107. The I/O interface 107 is coupled with the processor 111 through which an input signal or/and an output signal is communicated.

In some implementations, the primary edge network node 101 may include data 200 and modules 202. As an example, the data 200 may be stored within the memory 109 associated with the primary edge network node 101. In some embodiments, data 200 may include, for example, request data 204, deployment ability data 206, identification data 208, updated request data 210 and other data 212. In some embodiments, the data 200 may be stored in the memory 109 in form of various data structures.

The request data 204 may include requests received from the ASP 102. The request received from the ASP 102 may correspond to a deployment request for deploying EAS on a federated network. Further, the deployment request comprises requirements for deploying an application server. In an embodiment, the requirements may comprise attributes including but not limited to, requiredEASservingLocation, softwareImageInfo, affinity AntiAffinity, serviceContinuity, virtualResource, and the like.

The deployment ability data 206 corresponds to information related to capability of the primary edge network node 101 for deploying the EAS on its own EDNs. The deployment ability data 206 comprises the capability information when the primary edge network node 101 is capable of deploying the EAS on its own EDNs.

The identification data 208 comprises information about the secondary edge network node and an EDN which are identified based on the request data 204.

The updated request data 210 comprises identifier attributes associated with the identified secondary edge network node along with the requirements associated with the EAS to be deployed. The identifier attributes associated with the identified secondary edge network node comprises a federation identification number (federationID), an edge data network identifier (eDNID), and a reservation identifier (reservationID). The eDNID is associated with the EDN of the identified secondary edge network node for deploying the EAS and the reservationID is used for identifying a block of reserved resources for the primary edge network node 101 in the identified secondary edge network node. Further, the requirements associated with the EAS to be deployed comprises the request data 204.

The other data 212 may be stored data, including temporary data and temporary files, generated by the modules 202 for performing the various functions of the primary edge network node 101.

In an embodiment, the data 200 in the memory 109 are processed by the one or more modules 202 present within the memory 109 of the primary edge network node 101.

One or more modules 202 along with the data 200 functions to deploy the EAS on a federated edge network. In one implementation, the one or more modules 202 may include, but are not limited to, a request receiving module 214, a deployment ability determination module 216, an identification module 218, a request sending module 220 and one or more other modules 222.

In an embodiment, the one or more modules 202 may be implemented as dedicated units. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. In some implementations, the one or more modules 202 may be communicatively coupled to the processor 111 for performing one or more functions of the primary edge network node 101. The said modules 202 when configured with the functionality defined in the disclosure will result in a novel hardware.

The request receiving module 214 may receive a deployment request from the ASP 102 to deploy its services such as the EAS on the EDN from one or more EDNs associated with the primary edge network node 101. In an embodiment, the deployment request may be received from the ASP 102 in a form of a createMOI request operation for EASRequirements IOC as defined in 3GPP TS28.538. Further, on receiving the deployment request, the request receiving module 214 is configured to send back a response to the ASP 102 indicating acknowledgement of the deployment request. In an embodiment, the response is sent in the form of a createMOI response operation for EASRequirements IOC.

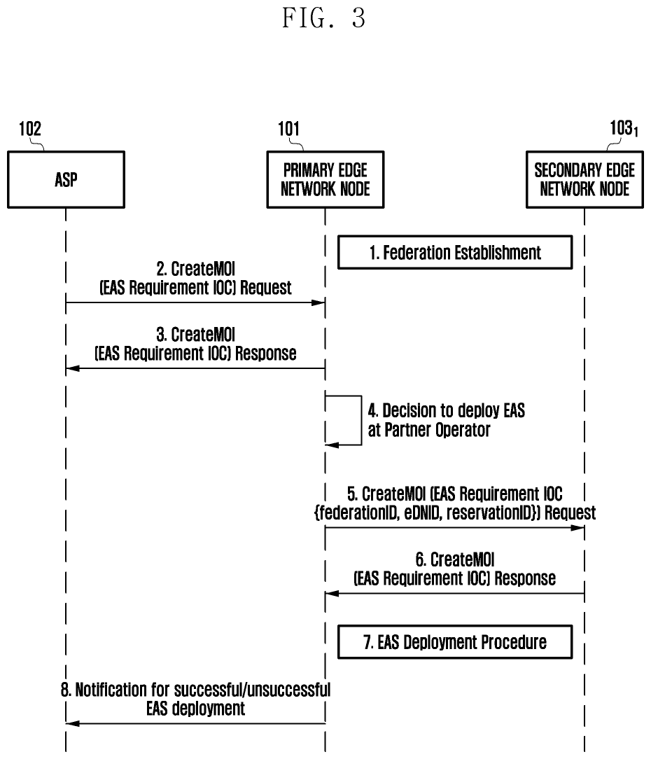

FIG. 3 illustrates a sequence diagram for deploying an edge application server on a federated edge network, according to an embodiment of the disclosure.

Referring to FIG. 3, as shown in steps 2 and 3 of FIG. 3, the request receiving module 214 of the primary edge network node 101 receives the createMOI request in the EASRequirements IOC from the ASP 102 and sends back a createMOI response operation for EASRequirements IOC to the ASP 102.

Returning to FIG. 2, the deployment ability determination module 216 is configured to receive the request data 204 from the request receiving module 214. On receiving the request data 204, the deployment ability determination module 216 is configured to determine whether the primary edge network node 101 is capable of deploying the EAS on the EDN which is maintained by itself based on the deployment request. Particularly, the deployment ability determination module 216 makes a decision by checking whether resources available at the one or more EDNs associated with the primary edge network node 101 are sufficient to satisfy the requirements as received in the request data 204. In an embodiment, the deployment ability determination module 216 may make a decision to deploy the requested EAS at one of its own EDNs when the resources at the respective EDN are sufficient to satisfy the requirements as received in the request data 204. Referring back to FIG. 3, at step 4, the deployment ability determination module 216 may decide to deploy the EAS at a partner operator, i.e., the secondary edge network node, say the secondary edge network node 1031. Returning back to FIG. 2, upon determining the inability to deploy the EAS at the primary edge network node 101, the deployment ability determination module 216 forwards the deployment ability data 206 to the identification module 218.

The identification module 218 may receive the deployment ability data 206 from the deployment ability determination module 216 when the inability to deploy the EAS on the one or more EDNs maintained by the primary edge network node 101 is determined. The identification module 218 is configured to first identify the secondary edge network node 1031 from the plurality of secondary edge network nodes 103 for deploying the requested EAS. In an embodiment, the primary edge network node 101 maintains a predefined federation association with each of the plurality of secondary edge network nodes 103, as shown in step 1 of FIG. 3. Returning to FIG. 2, upon identifying the secondary edge network node 1031, the identification module 218 identifies the EDN from the one or more EDNs associated with the identified secondary edge network node 1031. The identification module 218 identifies the secondary edge network node 1031 and the EDN from the one or more EDNs based on the requirements as received in the request data 204 and the predefined federation association maintained with each of the plurality of secondary edge network nodes 103. Particularly, the identification module 218 may perform the identification by correlating information associated with the predefined federation association of each of the plurality of secondary edge network nodes 103 with the requirements associated with the EAS to be deployed. In an embodiment, the predefined federation association is established between the primary edge network node 101 and each of the plurality of secondary edge network nodes 103 prior to receiving the deployment request for deploying the application server. Upon performing the identification by the identification module 218, the identification data 208 is sent to the request sending module 220.

The request sending module 220 is configured to send a request comprising updated deployment requirements to the identified secondary edge network node 1031. In an embodiment, the request may be sent by the request sending module 220 in a form of a createMOI request operation for EASRequirements IOC along with updated deployment requirements comprising identifier attributes associated with the identified secondary edge network node 1031. Further, similar to original deployment request, a response in a form of a createMOI response operation for EASRequirements IOC may be received by the request sending module 220 from the identified secondary edge network node 1031. As seen from steps 5 and 6 of FIG. 3, the request sending module 220 sends the createMOI operation for EASRequirements IOC {federationID, eDNID, reservationID}) request and further receives the createMOI response operation for EASRequirements IOC as an acknowledgement from the identified secondary edge network node 1031.

Upon sending the request comprising the updated deployment requirements to the identified secondary edge network node 1031, the identified secondary edge network node 1031 may coordinate with the one or more other modules 222 of the primary edge network node 101 for deploying the EAS on the identified EDN. As seen from step 7 of FIG. 3, the EAS deployment procedure is performed between the primary edge network node 101 and the identified secondary edge network node 1031. Further, at step 8, the primary edge network node 101 notifies the ASP 102 regarding successful or unsuccessful deployment of the EAS. In an embodiment, the deployment of EAS may be unsuccessful when the primary edge network node 101 is incapable of deploying the EAS and at the same instance, none of the plurality of secondary edge network nodes 103 are left with the resources for sharing with the primary edge network node 101. Thus, in such instances, the primary edge network node 101 sends an unsuccessful notification to the ASP 102.

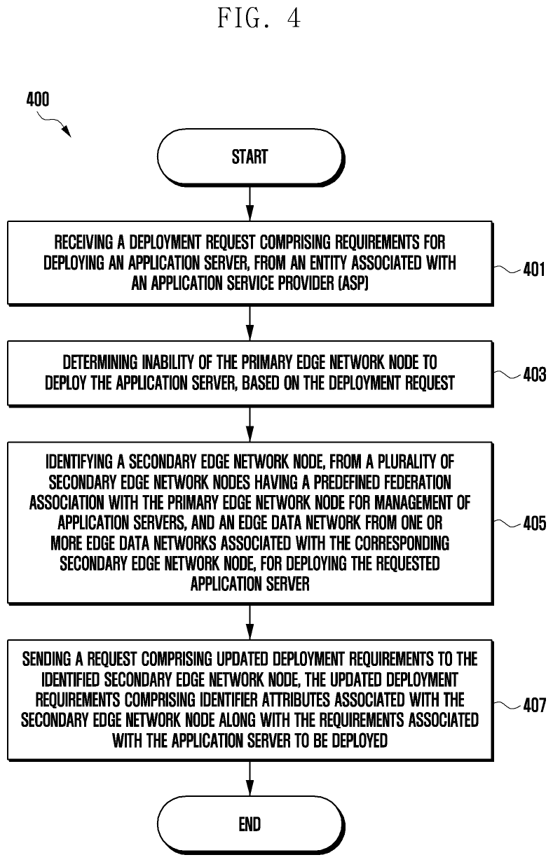

FIG. 4 is a flowchart illustrating a method for a primary edge network node for deploying application servers on a federated edge network, according to an embodiment of the disclosure.

Referring to FIG. 4, the method 400 comprises one or more blocks illustrating a method of deploying application servers on a federated edge network, in accordance with some embodiments of the disclosure. The method 400 may be described in the general context of computer-executable instructions. Generally, computer-executable instructions can include routines, programs, objects, components, data structures, procedures, modules, and functions, which perform functions or implement abstract data types.

The order in which the method 400 is described is not intended to be construed as a limitation, and any number of the described method blocks can be combined in any order to implement the method 400. Additionally, individual blocks may be deleted from the methods without departing from scope of the subject matter described herein. Furthermore, the method 400 can be implemented in any suitable hardware, software, firmware, or combination thereof.

At operation 401, the method 400 may include receiving, by a primary edge network node 101, a deployment request comprising requirements for deploying an application server, from an Application Service Provider (ASP).

At operation 403, the method 400 may include determining, by the primary edge network node 101, inability of the primary edge network node to deploy the application server, based on the deployment request.

At operation 405, the method 400 may include identifying, by the primary edge network node 101, a secondary edge network node 1031 having a predefined federation association with the primary edge network node 101. And further identify an Edge Data Network (EDN) associated with the corresponding secondary edge network node 1031, based on the deployment request, for deploying the requested application server.

At operation 407, the method 400 may include sending, by the primary edge network node 101, a request comprising updated deployment requirements to the identified secondary edge network node 1031. The updated deployment requirements further comprising identifier attributes associated with the secondary edge network node 1031 along with the requirements associated with the application server to be deployed. The identified secondary edge network node 1031 deploys the application server on the identified edge data network based on the request.

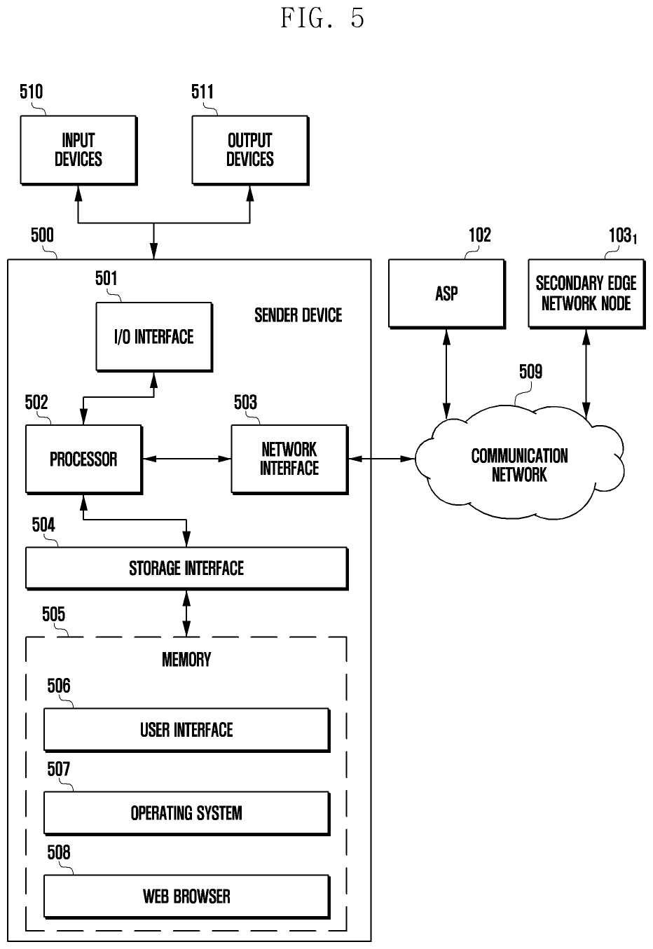

FIG. 5 is a block diagram of a computer system for implementing according to an embodiment of the disclosure.

Referring to FIG. 5, it illustrates a block diagram of a computer system 500 for implementing embodiments consistent with the disclosure. In some embodiments, the computer system 500 can be a primary edge network node 101 that comprises a processor (also referred as a processor 502 in this FIG. 5) that is used for deploying application servers on a federated edge network. The processor 502 may include at least one data processor for executing program components for executing user or system-generated business processes. The processor 502 may include specialized processing units such as integrated system (bus) controllers, memory management control units, floating point units, graphics processing units, digital signal processing units, etc.

The processor 502 may be disposed in communication with input devices 510 and output devices 511 via I/O interface 501. The I/O interface 501 may employ communication protocols/methods such as, without limitation, audio, analog, digital, stereo, Institute of Electrical and Electronics Engineers (IEEE)-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), Worldwide Interoperability for Microwave Access (WiMax), or the like), etc.

Using the I/O interface 501, computer system 500 may communicate with input devices 510 and output devices 511.

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 503 and the communication network 509, the computer system 500 may communicate with an ASP 102 and a plurality of secondary edge network nodes 103.

The communication network 509 can be implemented as one of the different types of networks, such as intranet or Local Area Network (LAN) and such within the organization. The communication network 509 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

Further, the communication network 509 may include a variety of network devices, including routers, bridges, servers, computing devices, storage devices, etc. In some embodiments, the processor 502 may be disposed in communication with memory 505 (e.g., RAM, ROM, etc. not shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, a user interface 506, an operating system 507, a web browser 508 etc. In some embodiments, the computer system 500 may store user/application data, such as the data, variables, records, etc. as described in this disclosure. Such databases may be implemented as fault-tolerant, relational, scalable, secure databases such as Oracle or Sybase.

Operating system 507 may facilitate resource management and operation of computer system 500. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like. User interface 506 may facilitate display, execution, interaction, manipulation, or operation of program components through textual or graphical facilities. For example, user interfaces may provide computer interaction interface elements on a display system operatively connected to computer system 500, such as cursors, icons, check boxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

The computer system 500 may implement web browser 508 stored program components. Web browser 508 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX, DHTML, ADOBE® FLASH®, JAVASCRIPT®, JAVA®, Application Programming Interfaces (APIs), etc. The computer system 500 may implement a mail server stored program component. The mail server may be an Internet mail server such as Microsoft Exchange, or the like. The mail server may utilize facilities such as ASP, ACTIVEX®, ANSI® C++/C#, MICROSOFT®. NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

An embodiment of the disclosure facilitates the primary edge network node 101 to maintain a predefined federation association with a plurality of secondary edge network nodes 103. As a result, the primary edge network node 101 is capable of deploying the EAS on the EDN associated with one of the pluralities of secondary edge network nodes 103. In the disclosure, the primary edge network node 101 is configured to receive a deployment request from the ASP and further identify the secondary edge network node and the EDN for deploying the EAS. The claimed disclosure performs the deployment of the EAS by sending the request comprising updated deployment requirements to the identified secondary edge network node 1031. Wherein the updated deployment requirements comprise identifier attributes associated with the secondary edge network node 1031 along with the requirements associated with the application server to be deployed. Therefore, in this manner, the disclosure facilitates the primary edge network node 101 to request for the deployment of the EAS at the EDNs which are maintained by the one of the secondary edge network nodes 103. Hence, in this manner, the disclosure enables an operator to request for deployment of an EAS on an EDN owned by a different operator.

### EQUIVALENTS

A description of an embodiment with several components in communication with each other does not imply that all such components are required. On the contrary a variety of optional components are described to illustrate the wide variety of possible embodiments of the disclosure. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The specification has described a system and a method for providing access to content associated with content providers. The illustrated steps are set out to explain the ˜embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a leading operator platform (L-OP) for deploying application servers on a federated edge network, the method comprising:
receiving, from an application service provider (ASP), a deployment request for deploying an application server;
checking whether the L-OP is able to deploy at least one application server based on the deployment request; and
in case that the L-OP is not able to deploy the at least one application server, selecting a participating operator platform (P-OP) from a plurality of P-OPs having a predefined federation association with the L-OP for management of application servers.

2. The method of claim 1, further comprising:
transmitting, to the selected P-OP, a request including deployment requirements including identifier attributes associated with the P-OP along with the requirements associated with the application server to be deployed.

3. The method of claim 2, wherein the identifier attributes comprise a federation identification number.

4. The method of claim 2, wherein the identifier attributes further comprise:
at least one of an edge data network identifier associated with an edge data network of the P-OP for deploying the application server, or a reservation identifier to identify a block of reserved resources for the L-OP in the P-OP.

5. The method of claim 1, wherein the application server comprises an edge application server (EAS).

6. The method of claim 1, further comprising:
identifying an edge data network (EDN) from one or more edge data networks associated with the corresponding P-OP based on the deployment request for deploying the requested application server,
wherein the selected P-OP deploys the application server on the identified EDN based on the deployment request.

7. The method of claim 1, wherein the predefined federation association is established between the L-OP and each of the plurality of P-OPs, prior to receiving the deployment request for deploying the application server.

8. A leading operator platform (L-OP) of a communication network for deploying application servers on a federated network, the L-OP comprising:
one or more processors; and
memory communicatively coupled to the one or more processors, wherein the memory store one or more computer programs including computer-executable instructions that, when executed by the one or more processors, cause the L-OP to:
receive, from an application service provider (ASP), a deployment request for deploying an application server,
check whether the L-OP is able to deploy at least one application server based on the deployment request, and
in case that the L-OP is not able to deploy the at least one application server, select a participating operator platform (P-OP) from a plurality of P-OPs having a predefined federation association with the L-OP for management of application servers.

9. The L-OP of claim 8, wherein the one or more computer programs further include computer-executable instructions that, when executed by the one or more processors, cause the primary edge network node to:
transmit, to the selected P-OP, a request including deployment requirements including identifier attributes associated with the P-OP along with the requirements associated with the application server to be deployed.

10. The L-OP of claim 9, wherein the identifier attributes comprise a federation identification number.

11. The L-OP of claim 9, wherein the identifier attributes further comprise:
at least one of an edge data network identifier associated with an edge data network of the P-OP for deploying the application server, or a reservation identifier to identify a block of reserved resources for the L-OP in the P-OP.

12. The L-OP of claim 8, wherein the application server comprises an edge application server (EAS).

13. The L-OP of claim 8, wherein the one or more computer programs further include computer-executable instructions that, when executed by the one or more processors, cause the L-OP to:
identify an edge data network (EDN) from one or more edge data networks associated with the corresponding P-OP based on the deployment request for deploying the requested application server,
wherein the selected P-OP deploys the application server on the identified EDN based on the deployment request.

14. The L-OP of claim 10, wherein the predefined federation association is established between the L-OP and each of the plurality of P-OPs, prior to receiving the deployment request for deploying the application server.
